(19) United States
(12) Patent Application Publication
(10) Pub. No.: US 2018/0139231 A1
(43) Pub. Date: May 17, 2018

(54) PROTECTING IAPS FROM DDOS ATTACKS

(71) Applicant: Telefonaktiebolaget LM Ericsson (publ), Stockholm (SE)

(72) Inventors: Dinand Roeland, Sollentuna (SE); Lasse Olsson, Träslövsläge (SE); Zoltán Turányi, Szentendre (HU); Zhang Fu, Stockholm (SE)

(73) Assignee: Telefonaktiebolaget L M Ericsson (publ)

(21) Appl. No.: 15/567,034

(22) PCT Filed: Jun. 10, 2015
(86) PCT No.: PCT/EP2015/062910

§ 371 Date: Oct. 16, 2017

(51) Int. Cl. H04L 29/06; H04L 29/12

(52) U.S. Cl. CPC H04L 63/1458; H04L 63/20; H04L 61/2076; H04L 61/2007; H04L 63/0236

(57) ABSTRACT

In a first aspect, a method performed by an Internet Protocol Advertisement Point (IAP) in a mobile service chaining network is provided for managing received data intended for an Internet Protocol (IP) address. The method comprises submitting a query to obtain an indication of a current location of a device designated by the IP address being included in the query, from a Location Registry (LR), receiving a reply indicating that the IP address included in the query is not in use, and starting a timer upon receiving the reply that the IP address is not in use. Further, the method comprises discarding received data intended for the IP address not in use until expiry of a set timer interval.

### TECHNICAL FIELD

The invention relates to methods and devices of managing received data intended for an Internet Protocol (IP) address in a mobile service chaining network. The invention further relates to computer programs and computer program products comprising computer readable medium having the computer programs stored thereon.

### BACKGROUND

A Denial of Service (DoS) attack is an attempt by an attacker to prevent legitimate users of a service from using the service, e.g. by intentionally saturating or exhausting system resources or setting the system providing the service in a fault mode in order to maliciously manipulate the system.

Generally speaking, the DoS attacks can be categorized into two groups; semantic attacks and brute force attacks. The semantic attacks aim at flaws of communication protocols (or their implementations) utilized in the system and send malformed or bogus packets to subvert the legitimate communications, e.g. Teardrop attacks, Ping of death, Border Gateway Protocol (BGP) poisoning. The brute force attacks aim at congesting a victim's network, exhausting network buffers or the victim's central processing unit (CPU) resources, by flooding a target with a massive amount of malicious packets (which in themselves could be correctly formed). This kind of attacks usually involves many compromised machines or so called “zombies” or “bots”, in order to flood the target with the packets simultaneously, which forms a Distributed Denial of Service (DDoS) attack.

In the concept of Mobile Service Chaining, Software Data Network (SDN) technology is utilized to intelligently chain service functions so that traffic from each subscriber only traverses a particular set of service functions as defined by a policy for a particular subscriber. Service chaining policies can also be applied to operator/user defined services. For example, an operator can configure a service chaining policy such that only web traffic is sent to a content optimization service.

With Mobile Service Chaining, the traffic path for any arbitrary flow can be dynamically changed by simply changing the policy associated with that flow in that an SDN controller automatically programs routers, switches and application servers in the network.

A key element within Mobile Service Chaining is an Internet Protocol (IP) Advertisement Point (IAP) enabling the facilitating of an anchorless network; i.e. a network without a mobility anchor point. An IAP advertises a range of IP addresses/prefixes for devices, such as mobile terminals, towards an IP network. This may be Internet or an operator-internal network.

A control plane of a communications network, such as e.g. an evolution of a 3rd Generation Partnership Project (3GPP) Long-Term Evolution (LTE) technology network in which a mobile service chaining network maybe implemented, may contain a Location Registry (LR). This is a table of entries, where each entry is a mapping from device IP address/prefix to current device location and possibly to a device identifier (ID). The previous may be encoded as a base station (BS) ID, which base station is referred to as an eNodeB in LTE. When a device moves from one BS to another, a control plane node ensures that the BS ID in the LR is updated with the new location. In LTE, this CP node may be embodied by a Mobility Management Entity (MME).

An IAP is only used for downlink packets. For each downlink packet, the IAP performs the following 1) query the LR based on the destination IP address of the packet in order to retrieve (at least) a current device location; 2) tag the packet with a location ID representing the device location; and 3) forward the packet to the appropriate destination as designated by the tags and/or other header information. In a mobile service chaining network, the packet will transverse one or more UPFs before reaching the mobile terminal, i.e. its final destination. Note that the LR can be implemented in a distributed fashion. For instance, the IAP query may be performed towards an IAP-internal cache. Only if no entry is found in that cache, the CP node is queried. For non-mobile devices, implementing the query is simplified as the entry in the LR for that device will not change.

Hence, the IAP may need to query the global LR for an IP address that is unknown in its local LR, which typically takes time. If additional packets arrive at the IAP to that particular IP address during the query, then the IAP needs to buffer those packets. Typically, the IAP would announce many IP addresses, and therefore a situation may arise where the IAP has multiple outstanding queries towards the LR, one for each IP address unknown in its local LR. For each outstanding query, the IAP needs to buffer additional packet for that IP address.

An attacker may exploit the IAP query to the global LR to perform a DDoS attack. In particular, it could flood the IAP with packets destined to all individual IP addresses within the range that the IAP announces. If the range is big enough and the data rate of the packets is high enough, then the IAP buffer may overflow. As a consequence, data packets of legitimate users may not get served anymore by the IAP.

### SUMMARY

An object of the present invention is to solve, or at least mitigate, this problem in the art and thus to provide improved methods and devices for managing received data intended for an Internet Protocol (IP) address in a mobile service chaining network.

This object is attained in a first aspect of the invention by a method performed by an Internet Protocol Advertisement Point (IAP) in a mobile service chaining network of managing received data intended for an Internet Protocol (IP) address. The method comprises submitting a query to obtain an indication of a current location of a device designated by the IP address being included in the query, from a Location Registry (LR), receiving a reply indicating that the IP address included in the query is not in use, and starting a timer upon receiving the reply that the IP address is not in use. Further, the method comprises discarding received data intended for the IP address not in use until expiry of a set timer interval.

This object is attained in a second aspect of the invention by a method performed by an IAP in a mobile service chaining network of managing received data intended for an IP address. The method comprises receiving an indication of IP addresses not being in use, receiving data intended for a particular IP address, and discarding the received data intended for the particular IP address, if said particular IP address is not in use.

This object is attained in a third aspect of the invention by a method performed by at least one control plane node of allocating IP addresses to at least one IAP in a mobile service chaining network. The method comprises allocating a set of IP addresses upon receiving a request to allocate at least one IP address included in the set to a device, and submitting, to the at least one IAP, an indication of the allocation of the set of IP addresses.

Correspondingly, the object is attained by devices corresponding to the above mentioned methods of the first, second and third aspect of the invention.

Thus, further provided is an IAP configured to manage received data intended for an IP address in a mobile service chaining network, which comprises a processing unit and a memory, the memory containing instructions executable by the processing unit, whereby the IAP is operative to submit a query to obtain an indication of a current location of a device designated by the IP address being included in the query, from an LR, receive a reply indicating that the IP address included in the query is not in use, start a timer upon receiving the reply that the IP address is not in use, and discard received data intended for the IP address not in use until expiry of a set timer interval.

Further provided is an IAP configured to manage received data intended for an IP address in a mobile service chaining network, which comprises a processing unit and a memory, the memory containing instructions executable by the processing unit, whereby the IAP is operative to receive an indication of IP addresses not being in use, receive data intended for a particular IP address, and discard the received data intended for the particular IP address, if the particular IP address is not in use.

Further provided is a control plane node configured to allocate IP addresses to at least one IAP in a mobile service chaining network, which comprises a processing unit and a memory, the memory containing instructions executable by the processing unit, whereby the control plane node is operative to allocate a set of IP addresses upon receiving a request to allocate at least one IP address included in the set to a device, and submit, to the at least one IAP, an indication of the allocation of the set of IP addresses.

Advantageously, in the first aspect of the invention the problem with subjecting the IAP to attacks upon making queries to the global LR in the control plane can be solved, or at least mitigated, by not immediately re-sending a new query from the IAP to the global LR when the previous query for that IP address resulted in “no location found” response, i.e. a response lacking an indication of a current location of a device assumed to be associated with the IP address. In the first aspect, a timer is implemented per IP address which needs to expire before a new query is performed towards the LR.

Hence, when receiving an IP packet at the IAP intended for an IP address not present in a local cache of the IAP, the IAP needs to find the current location in the global LR of a device assumed to be associated with the IP address. The IAP starts buffering any incoming packets and performs a query to the global LR via a CP node.

If the CP node responds to the IAP that the particular IP address comprised in the query is not in use, i.e. no device is found to be associated with the IP address, the IAP advantageously starts a timer for the IP address and starts discarding buffered packets intended for the IP address. Any further packets intended for this unused IP address that are received before the expiry of the timer will be discarded. Only after the timer has expired, new queries for this IP address to the global LR may be performed again.

Advantageously, in the second aspect of the invention, the IAP is informed by the CP node which IP addresses are unused. The IAP can thus discard packet(s) destined for an unused address and skip the query towards the global LR in the control plane.

Hence, the IAP receives from the CP node a list of unused IP addresses of each device for the IP addresses included in the set of IP addresses announced by that particular IAP. When the IAP is made aware that an address is not in use, it can simply discard packets for such address. Thus, when the IAP receives a first packet (from a potentially malicious party) which turns out to be intended for an unused IP address, the first packet is advantageously discarded by the IAP.

Advantageously, in the third aspect of the invention, when (at least) a first IP address is required, for instance by a device such as a mobile terminal performing an attach procedure, the CP node will allocate a set, or block, of IP addresses—say 256 addresses at a time. Subsequently, the CP node signals the IAPs to indicate that the allocated set of IP addresses are in use. In this particular example, only one is in fact used; namely that associated with the attaching mobile terminal, while 255 IP addresses are not in use.

Preferably, for the IP address that indeed is in use and associated with the mobile terminal, the CP node will include the current location of the mobile terminal, such that the IAP can forward packets intended for the mobile terminal without any further queries made to the CP node.

However, for a packet received and intended for any of the other 255 IP addresses included in the allocated set, the IAP(s) will advantageously have to query the CP node, which will reply that the IP address(es) is not in use by returning a “no location found” message, and the IAP can discard packets intended for those IP addresses. Advantageously, each IAP will keep track of used/unused status per allocated set instead of per individual IP address.

In an embodiment applicable to all aspects of the invention, when a device later attaches and is assigned a particular IP address that previously has been indicated to be unused, the CP node informs the IAP that this address is now in-use and indicates to the IAP a current location of the device now associated with the IP address. Advantageously, if another device addresses a packet to this particular IP address now being in use, the IAP performs a look-up in in the LR of its local cache, finds the particular IP address stored therein and the associated device location, and forwards the packet towards its destination. Thus, in the particular embodiment, the IAP can be viewed upon as placing a “subscription” with the CP node for IP addresses coming into use, which previously was indicated as unused.

It should be noted that the CP node is described to inform the IAP which advertised IP addresses that are not in use. However, the CP node could alternatively inform the IAP which of its advertised IP addresses are in use, whereupon the IAP easily itself may conclude whether an advertised IP address is in use or not.

Further provided are computer programs for causing a device to perform the methods according to the invention, and computer program products comprising computer readable medium having the computer programs stored thereon.

Further embodiments of the invention will be described in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates a mobile service chaining network in which the invention advantageously may be implemented;

FIG. 2 illustrates a mobile service chaining network in which the invention advantageously may be implemented;

FIG. 3 illustrates a user plane traffic example in the form of an Internet packet exchange between a mobile terminal and a peer device;

FIG. 4 illustrates a mobile service chaining network in which an embodiment of the invention advantageously is implemented;

FIG. 5 illustrates a mobile service chaining network in which an alternative embodiment of the invention advantageously is implemented;

FIG. 5 illustrates a mobile service chaining network in which an alternative embodiment of the invention advantageously is implemented;

FIG. 5 illustrates a mobile service chaining network in which an alternative embodiment of the invention advantageously is implemented;

FIG. 6 illustrates an IAP according to an embodiment of the invention;

FIG. 7 illustrates an IAP according to a further embodiment of the invention; and

FIG. 8 illustrates a CP node according to an embodiment of the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

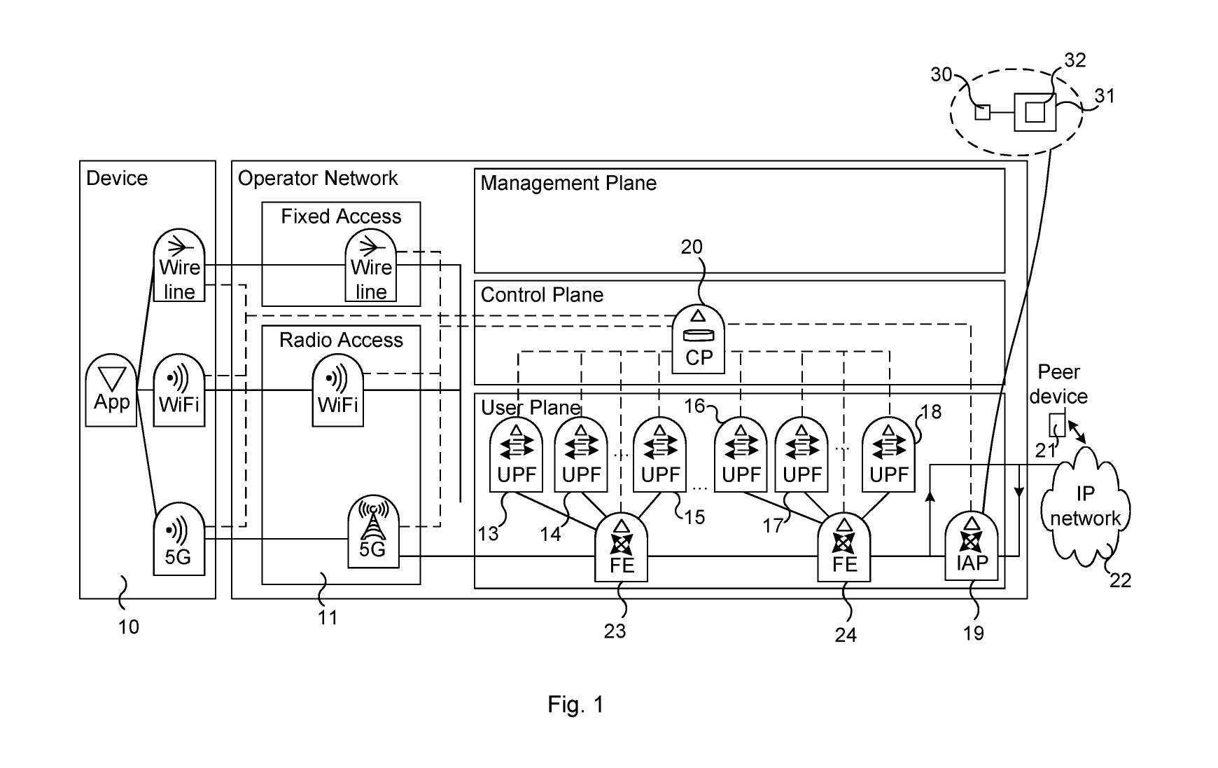

FIG. 1 shows a generic architecture of a mobile service chaining network illustrated as a functional architecture. The functional architecture may run on a platform that may be distributed over multiple sites, like a distributed cloud.

The architecture is divided into a control plane, a user plane and a management plane. Generally speaking, the control plane carries signalling traffic, while the user plane carries data traffic. In FIG. 1, control plane traffic is indicated by means of dashed lines while user plane traffic is indicated by means of continuous lines. The management plane carries operations and administration traffic required for network management and will not be further discussed herein. Further, the control plane is depicted as a single logical element or node 20. However, in an implementation, the CP node 20 may be distributed.

A device 10 communicates with the CP node 20 and the user plane via one or more accesses. An access node will in the following be exemplified as a Base Station (BS) 11, but the concept is equally applicable to all accesses including fixed access.

The CP node 20 contains all control plane logic, allowing for a strict separation between control and user plane. It contains, amongst others, mobility handling such as an MME located in an EPC network in case of an LTE implementation.

The mobile service chaining network illustrated in FIG. 1 comprises User Plane Functions (UPFs) denoted 13-18. A UPF processes user plane packets, which may include altering the packet's payload and/or packet header. UPFs are not expected to know topological information regarding the chain, including which other UPFs are in the chain and how to reach them. A UPF may serve multiple users, and may keep context per user.

The mobile service chaining network may further comprise one or more Forwarding Elements (FEs) 23, 24. An FE forwards each packet to one of its ports based on rules it has received from the CP node 20. An FE may forward a packet through one or more UPFs. An FE is only concerned with the actual forwarding; it does not classify or modify a packet.

The mobile service chaining network illustrated in FIG. 1 further comprises an Internet Protocol (IP) Advertisement Point (IAP) 19 enabling the facilitating of an anchorless network; i.e. a network without a mobility anchor point. An IAP advertises a range of IP addresses/prefixes towards an IP network 22 to which a number of peer devices 21 may be connected. This may be Internet or an operator-internal network. A single IP address/prefix may be advertised by multiple IAPs. If the IP address of a specific device is advertised by multiple IAPs, then packets for that device can enter the network via any of those IAPs (the device may thus be connected to multiple IAPs). Similarly, an anchored approach can be achieved by allowing only a single IAP to advertise the IP address for that device.

The control plane contains a Location Registry (LR). This is a table of entries, where each entry is a mapping from device IP address/prefix to current device location and optionally device identifier (ID) in case the IP address is not considered sufficient to identify the mobile terminal. The current device location may be encoded as a BS ID, i.e. an identifier designating the BS on which the mobile terminal currently camps.

When a device moves from one BS to another, the CP node 20 ensures that the BS ID in the LR is updated with the new location. An IAP is only used for downlink packets. For each downlink packet, the IAP does: 1) query the LR based on the destination IP address of the packet in order to retrieve current location (e.g. BS ID) and optionally device ID; 2) tag the packet with a location identifier and optionally the device ID; 3) forward the packet to the appropriate destination. Note that the LR can be implemented in a distributed fashion. For instance, the IAP query may be performed towards an IAP-internal cache. Only if no entry is found in that cache, the CP node 20 is queried. For non-mobile devices, implementing the query is simplified as the entry in the LR for that device will not change.

If implemented in an EPC network, the part of the mobile service chaining network shown in FIG. 1 comprising the UPFs, the FEs and the IAP would typically be interfaced to an SGi reference point, between an IP network and a Packet Data Network Gateway (PGW). It may further be envisaged that functionality of the current PGW and Serving Gateway (SGW) can be moved to the mobile service chaining network connected to the SGi.

In practice, the steps of the method performed by the IAP 19 according to embodiments of the invention, is caused by a processing unit 30 embodied in the form of one or more microprocessors arranged to execute a computer program 32 downloaded to a suitable storage medium 31 associated with the microprocessor, such as a Random Access Memory (RAM), a Flash memory or a hard disk drive. The processing unit 30 is arranged to cause the IAP 19 to carry out at least one step of the method according to embodiments of the present invention when the appropriate computer program 32 comprising computer-executable instructions is downloaded to the storage medium 31 and executed by the processing unit 30. The storage medium 31 may also be a computer program product comprising the computer program 32. Alternatively, the computer program 32 may be transferred to the storage medium 31 by means of a suitable computer program product, such as a Digital Versatile Disc (DVD) or a memory stick. As a further alternative, the computer program 32 may be downloaded to the storage medium 31 over a network. The processing unit 30 may alternatively be embodied in the form of a digital signal processor (DSP), an application specific integrated circuit (ASIC), a field-programmable gate array (FPGA), a complex programmable logic device (CPLD), etc. The CP node 20 (or system of CP nodes) will correspondingly comprise a processing unit arranged to execute a computer program downloaded to a suitable storage medium associated with the processing unit, for performing the steps of the method performed by the CP node 20 according to embodiments of the invention.

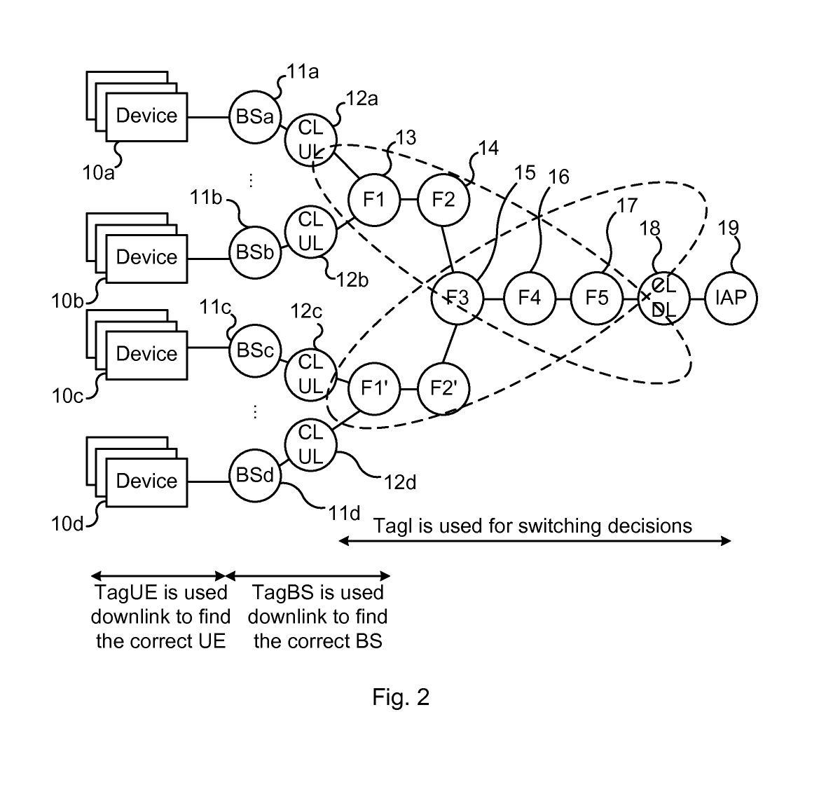

FIG. 2 illustrates a mobile service chaining network in which the invention advantageously may be implemented. This exemplifying mobile service chaining network, illustrating a mobile broadband use case, comprises a group of devices 10a-d, typically being mobile terminals, and referred to in the following as User Equipment (UE), base stations (BSs) 11a-d, and UPFs referred to as F1-F5 (and F1′, F2′) denoted 13-16 (and 13′ 14′), respectively.

In the mobile broadband use case, the mobile terminal may be embodied in the form of a smart phone, tablet, smart watch, laptop, etc., commonly referred to as UE. However, in a general use case, the device may be a non-mobile device such as computer, a television set, a set-top box, a video game console, etc.

The mobile service chaining network illustrated in FIG. 2 comprises User Plane Functions (UPFs) referred to as F1-F5 (and F1′, F2′) denoted 13-16 (and 13′ 14′), respectively.

The mobile service chaining network illustrated in FIG. 2 further comprises an IAP 19 enabling the facilitating of an anchorless network; i.e. a network without a mobility anchor point, as was described with reference to FIG. 1.

The IAP of the mobile service chaining network is the key component to achieve an anchorless architecture. This in contrast to the core network in LTE known as Evolved Packet Core (EPC) as defined in 3GPP specification TS 23.401, where a a Packet Data Network Gateway (PGW) acts as an anchor point. Multiple IAPs may announce the same IP address, thereby achieving an anchorless architecture.

Packets are forwarded to different UPFs and BSs according to which service chain the packets need to traverse and where the corresponding devices are located. Such information is added to the packet as tags by a downlink (DL) 18 and an uplink classifier (CL) 12a-d for each BS. A classifier CL is a UPF that determines which service chain a packet takes based on the packet header and rules it has received from the CP node (not shown in FIG. 2). A CL may change the packet's header, e.g. adding a tag to indicate which service chain the packet traverses. A CL may contact the CP node when a packet cannot be classified, or it may drop such packet. The classifier can be configured by the CP node with rules at several occasions, such as before, during or after a UE attaches.

The exemplifying mobile broadband service chain network of FIG. 2 uses four BSs 11a-11d; BSa through BSd. Each BS serves a plurality of UEs. F5 is a firewall UPF. This function may be placed high up in the chain; e.g. in a national data centre. F4 and F3 are UPFs for charging and parental control, respectively. These may be placed in the same data centre as the firewall. F1 and F2 are UPFs placed closer to the BS; e.g. in an aggregation site. These could e.g. perform access network protocol handling or bandwidth limiting. F1 only serves a subset of the BSs. Another instance of the same UPF, i.e. F1′, serves the other subset. F1 and F1′ are placed in different sites, and so are F2 and F2′. The uplink classifier CL(UL) is placed between BS and F1, and the downlink classifier CL(DL) between IAP and F5. Note that the downlink classifier CL(DL) determines both the service chain type, i.e. mobile broadband in this example, and the service chain instance, i.e. in this example if traffic should traverse F5-F4-F3-F2-F1 or F5-F4-F3-F2′-F1′.

In this use case, three tags are used for most of the traffic. The chain of functions F1-F2-F4-F5 is used by all packets. These get tagged by the uplink and downlink classifiers CL(UL) and CL(DL) with “TagI”, where I stands for Internet traffic. In the downlink, the IAP adds “TagBS” which identifies the location of the BS the UE is currently connected to. The third tag, “TagUE”, is also added by the IAP and identifies the UE itself. As shown in FIG. 2, TagI is used to make forwarding decisions between F1 and F5. TagBS is used only in the downlink by the FE (not shown) of F1 to find the correct BS, while TagUE is used by the BS to find the correct UE. A fourth tag, “TagP”, is set in case this user has subscribed to the parental control service. The UPF of F3 is only involved by the FE of F3 if TagP is set.

Hence, by using different tags, in this case TagI=x and TagI=y, data packets can advantageously traverse different routes in the network.

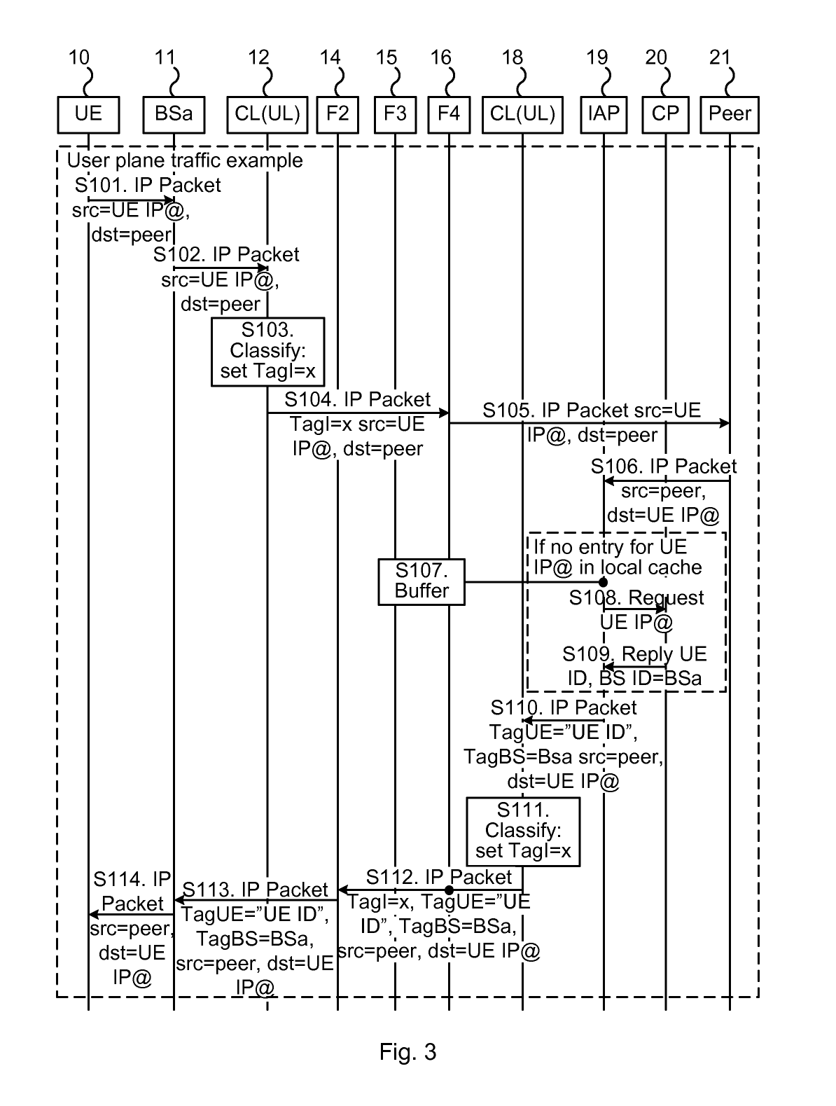

FIG. 3 illustrates a user plane traffic example in the form of an Internet packet exchange between a UE 10 and a peer device 21, being for instance a laptop, via a mobile service chaining network. In a first step S101, the UE 10 sends an IP packet to the BS 11 indicating a packet source in the form of the IP address of the UE 10, as well as a packet destination designating the peer device 21. The BS 11 forwards in step S102 the IP packet to the uplink classifier CL(UL) 12, which tags the packet with TagI=x indicating internet transfer using route x. In this particular example, the route undertaken via steps S104 and S105 is F2-F4-peer device 21.

In step S106, the peer device 21 sends an IP packet to the IAP 19 indicating a packet source (peer), as well as a packet destination designating the UE 10 in the form of the IP address of the UE 10.

When the IAP 19 receives the downlink packet from the peer device 21, it needs to find the current location of the UE 10 in the LR. As previously mentioned the LR is logically a single entity but may be implemented in a distributed way. Each IAP may have a cache with a local LR. If no entry for the IP address of the UE 10 is found in the local cache of the IAP 19, the IAP may perform a query to the global LR. The query to the global LR may take time, and during that time additional downlink packets heading towards the same UE IP address may be sent to the IAP 19. The IAP 19 hence needs to implement a buffering mechanism and starts buffering incoming packet in step S107. It is assumed that the global LR is contained within the CP, so the IAP 19 sends in step S108 a request to the CP node 20, which replies in step S109 with UE ID and the ID of the particular base station, i.e. BS ID=BSa for this particular IP address.

The IAP 19 thus tags the packet with UE ID and BSa ID and sends it in step S110 to the downlink classifier CL(DL) 18, which tags the packet in step S111 with TagI=x indicating internet transfer using route x. In this particular example, the route undertaken via steps S112 and S113 is F4-F2-BSa 11. Finally, BSa 11 delivers the packet to the UE 10.

As previously has been mentioned, an attacker may exploit the IAP query to the global LR to perform a DDoS attack. In particular, it could flood the IAP 19 with packets destined to all individual IP addresses within the range that the IAP 19 announces. If the range is big enough and the data rate of the packets is high enough, then the IAP buffer may overflow. As a consequence, data packets of legitimate users may not get served anymore by the IAP 19.

This DDoS attack towards an IAP will in particular arise if the query to the LR is for an IP address that is not in use. That is, an IP address that is within the announced set of IP addresses, but not assigned by the CP node 20 to any UE. The LR keeps track of the current location of each UE. In a naive IAP implementation, an LR query to an unused IP address will return “no location found”. Thereafter, a new incoming packet towards the same unused IP address would result in a new query towards the global LR. Thus by flooding the packets with the unused IP addresses, the attacker can keep the IAP 19 busy with querying the LR and buffering the bogus packets.

In a traditional EPC network, the PGW performs the corresponding functions of an IAP. However, since the EPC network is an anchored architecture, every individual IP address is only announced by a single PGW. Each PGW has its own set of announced IP addresses, which is not overlapping with any other PGW. Therefore, the PGW also knows which of the IP addresses is used and which is unused. There is no need to query a global LR. Therefore, the problem with attacks in a mobile service chaining network as described above does not arise in a traditional EPC network.

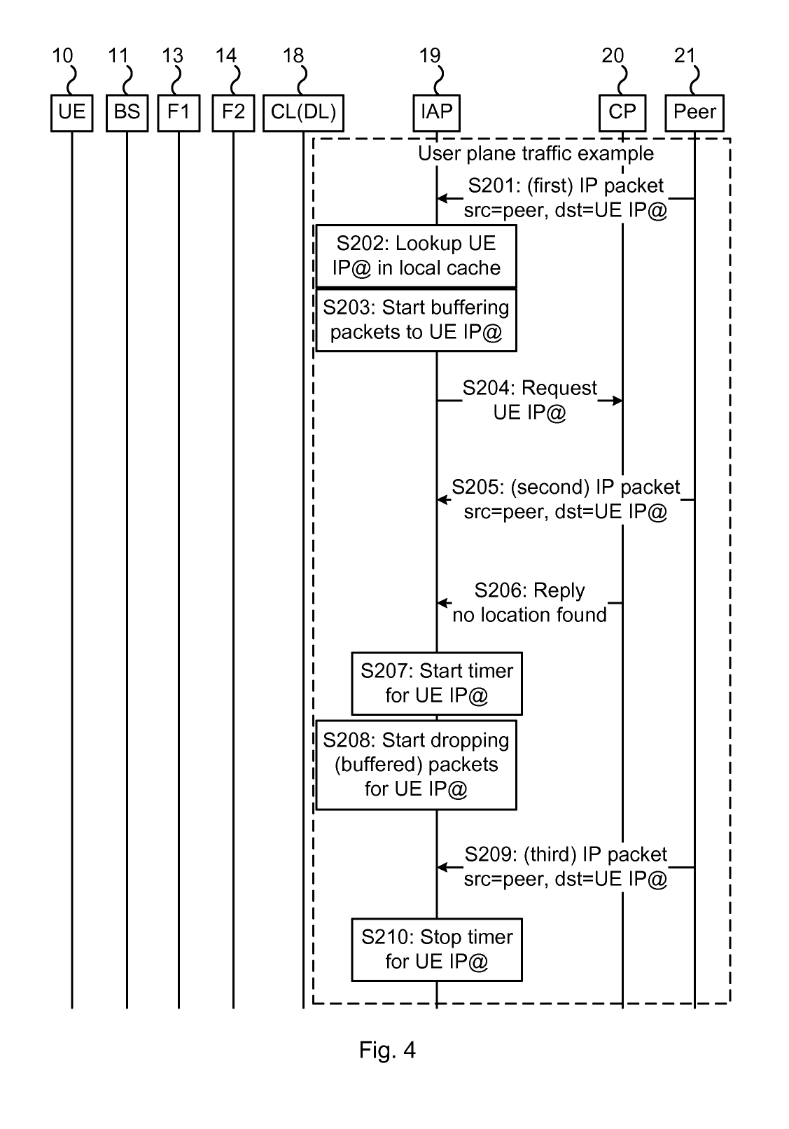

FIG. 4 illustrates a mobile service chaining network in which an embodiment of the invention advantageously is implemented. In this exemplifying mobile service chaining network, a UE 10 connects to CP node 20 via BS 11. In case of LTE, the BS 11 is an eNodeB, and the CP node 20 contains an MME.

The mobile service chaining network illustrated in FIG. 4 comprises two UPFs referred to as F1 and F2 denoted 13, 14, respectively. F1 and F2 may e.g. perform functions such as access network protocol handling or bandwidth limiting. As previously described, the mobile service chaining network further comprises a downlink classifier CL(DL) 18 and an IAP 19.

In FIG. 4, a peer device 21 is to submit one or more data packets to the UE 10. The problem with subjecting the IAP 19 to attacks upon making queries to the global LR in the control plane can be solved, or at least mitigated, by not immediately re-sending a new query to the global LR when the previous query for that IP address resulted in “no location found” response, i.e. a response lacking an indication of a current location of the UE 10. For instance, in the present embodiment, a timer is implemented per IP address which needs to expire before a new query is/can be performed.

In this exemplifying embodiment, the peer device 21 sends three packets to an address that is unknown to the IAP 19.

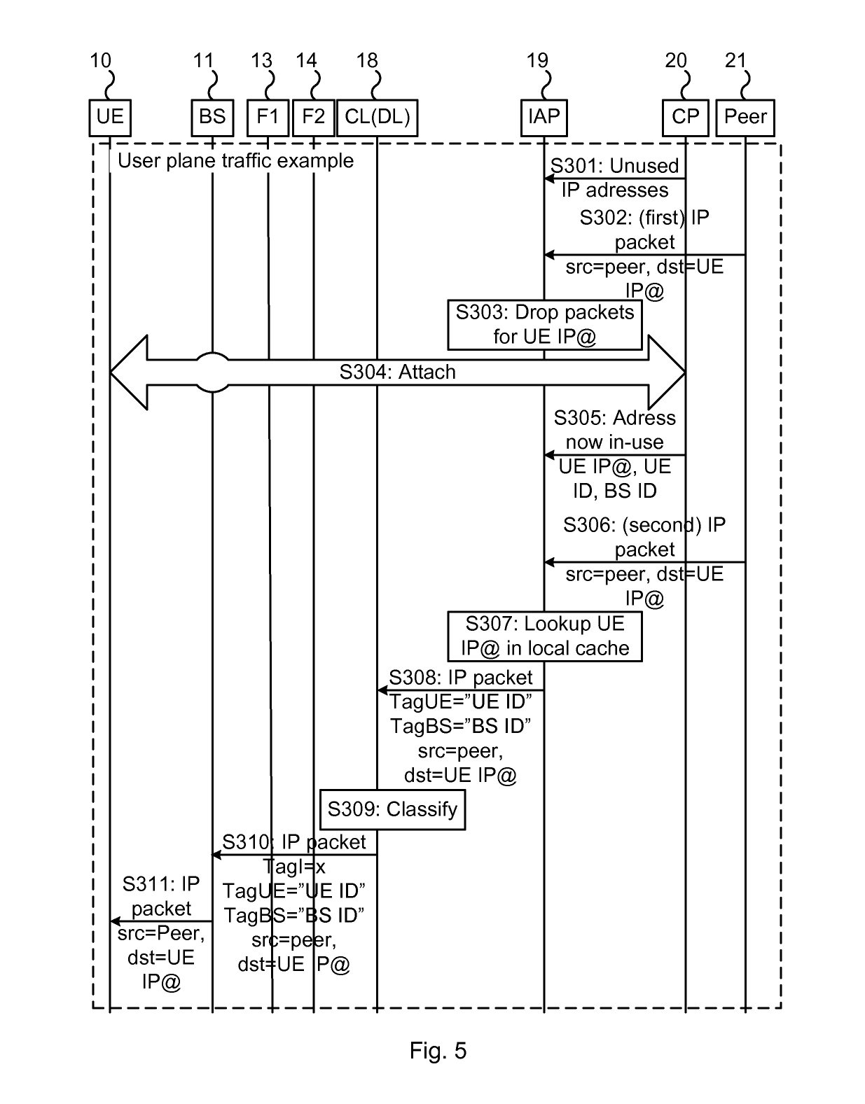

In a first step S201, the peer device 21 sends an IP packet to the IAP 19 over the Internet. In the packet, a packet destination is indicated in the form of the IP address of the UE 10, as well as a packet source designating the peer device 21. When the IAP 19 receives the downlink packet from the peer device 21, it needs to find the current location of a device assumed to be associated with the IP address in the LR, and performs a look-up in step S202 in its local cache accommodating a local LR. If no entry for the IP address of the UE 10 is found in the local cache of the IAP 19, the IAP starts buffering the incoming packets in step S203 and performs a query to the global LR. It is assumed that the global LR is contained within the CP, so the IAP 19 sends in step S204 a request accordingly to the CP node 20. In FIGS. 4 and 5, the CP node 20 is illustrated as a single node. However, in an embodiment, it is envisaged that the CP functionality is distributed over a plurality of nodes, in which case the “CP node” 20 would comprises a number of different CP nodes interacting to achieve the functionality of the single CP node 20 described herein.

Before having received a response from the CP node 20 to the query, a second packet destined to the IP address is received from the peer device 21 in step S205, which second packet is buffered at the IAP 19. Thereafter, in step S206, the CP node 20 responds to the IAP 19 that the particular IP address to which the peer device 21 directs a packet is not in use.

Thus, the IAP 19 advantageously starts a timer for the IP address in step S207 and starts discarding buffered packets intended for the IP address in step S208, i.e. the first and second packet. Any further packets intended for this unused IP address that are received before the expiry of the timer will be discarded. As a consequence, a third packet received in step S209 is also discarded since the timer does not expire until step S210; only after the timer has expired in step S210, new queries for this IP address to the global LR may be performed again.

A difficulty with using the timer is that an appropriate trade-off must be made when setting its timing interval; if the interval is too short, a malicious peer device 21 could still overflow the IAP 19 after the (short) interval has expired. In contrast, if the interval is too long, a new UE entering the network during the set interval, which uses the particular IP address which was reported as not being in use, will be unreachable.

FIG. 5 illustrates a mobile service chaining network in which a further embodiment of the invention advantageously is implemented. In this embodiment, the IAP 19 is informed by the CP node 20 which IP addresses are unused. The IAP 19 can thus advantageously discard packet(s) destined for an unused address and skip the query towards the global LR in the control plane.

In the art, a CP node assigns an IP address (or IP prefix in the IPv6 case) to a UE when it attaches, or when it already is attached but requests establishment of an additional Packet Data Network (PDN) session. Such procedure is performed in step S304 of FIG. 5. The CP node does not release such IP address until the UE detaches, or at least releases a PDN session associated with this IP address.

In a first step S301, the IAP 19 receives from the CP node 20 a list of unused IP addresses of each UE for the IP addresses included in the set of IP addresses announced by that particular IAP 19. When the IAP 19 is made aware that an address is not in use, it can simply discard packets for such address. Hence, in step S302, when the IAP 19 receives a first packet from the peer device 21, which turns out to be intended for an unused IP address, the first packet is advantageously discarded by the IAP 19 in step S303. When the UE 10 later attaches and is assigned this particular IP address in step S304, the CP node informs in step S305 the IAP 19 that this address is now in-use and indicates to the IAP 19 a current location of the UE 10 associated with the IP address. The indication of the current location of the UE 10 may be embodied e.g. in the form of a BS ID for the BS 11 currently serving the UE 10. Optionally, a UE ID may be included in the submission of step S306 along with the IP address.

Assuming now that the peer device 21 addresses a second packet to this particular IP address in step S306, the IAP 19 performs a look-up in in the LR of its local cache in step S307 and thus finds the particular IP address stored therein.

The IAP 19 thus forwards the second packet towards its destination in step S308, optionally tagging the second packet with UE ID and BS ID for this particular IP address. The classifier CL(DL) 18 tags the packet in step S309 with TagI=x indicating Internet transfer using route x. In this particular example, the route undertaken via step S310 is F2-F1-BS. Finally, BS 11 delivers the packet to the UE 10 in step S311.

With reference to FIG. 5, at each IAP 19, an IP address may be:
a) unused; wherein packets intended for this address shall be dropped (see step S303),
b) used with device location known; packets shall be forwarded with location tags added (see step S308), or
c) used but device location is not known; wherein for packets intended for this address, the LR shall be queried to obtain device location (not shown).

It should be noted that the CP node 20 informs the IAP 19 which advertised IP addresses that are not in use in step S301. However, the CP node 20 could alternatively inform the IAP 19 which of its advertised IP addresses are in use, whereupon the IAP 19 easily itself may conclude whether an advertised IP address is in use or not.

Again with reference to FIG. 5, to relieve each IAP from the task of having to keep track of which of the IP addresses that the respective IAP advertises are used/unused, a further embodiment will be discussed.

When (at least) a first IP address is required, for instance by the UE 10 performing an attach procedure in step S304, the CP node 20 will allocate a set, or block, of IP addresses—say 256 addresses at a time.

Subsequently, in step S305, the CP node 20 signals the IAPs to indicate that the allocated set of IP addresses are in use. In this particular example, only one is in fact used; namely that associated with the UE 10, while 255 IP addresses are not in use.

In a preferred embodiment, for the IP address that indeed is in use and associated with the UE 10, the CP node will in step S305 include the current location of the UE (e.g. as a BS ID), such that the IAP 19 can forward packets intended for the UE 10 without any further queries made to the CP node 20.

However, for a packet received and intended for any of the other 255 IP addresses included in the allocated set, the IAP(s) will advantageously have to query the CP node 20, which will reply (cf. step S206 in FIG. 4) that the IP address(es) is not in use by returning a “no location found” message, and the IAP 19 can discard packets intended for those IP addresses.

Advantageously, each IAP will keep track of used/unused status per allocated set instead of per individual IP address.

The CP node 20 shall strive to prevent fragmentation of the range of allocated IP addresses; if an IP address is released from a mid-section of a set, it shall preferably be selected when a new IP address is required.

Hence, this embodiment of allocating a set of IP addresses decreases rounds of signalling required for determining whether an IP address is used/unused, but it leaves the allocated IP addresses in the set that are not used vulnerable to attacks; a malicious party pinging any of these IP addresses will result in a query being made by the IAP(s) 19 to LR via the CP node 20.

In an embodiment of the invention, the CP node 20 will submit status updates to the IAP 19 for any IP address queried by the IAP 19, even if the query has returned “no location found”, as will be described in the following.

With reference to the prior art procedure of FIG. 3, when an IAP 19 queries the LR via the CP node 20 for an IP address in step S108 and the LR returns the location of the UE 10 having that IP address in step S109, the IAP 19 normally also subscribes to further updates to the location changes of that IP address. That is, if the UE 10 moves, its new location is pushed by the LR to all IAPs that have previously queried this IP address. This “subscription” is cancelled either by the UE 10 releasing this PDN session and the IP address with it, or by the UE detaching. The IAP 19 may also time out this subscription if no packets arrive to the IP address in question and can cancel its subscription at the LR via explicit signalling. It should be noted that the step of subscribing is implicitly included in the query; if the query returns a location, the IAP 19 is automatically subscribed, without further messaging.

With reference to FIG. 5, in an embodiment of the invention, to facilitate DDoS protection, the IAP 19 subscribes to updates for the queried IP address even if a returned reply indicates that no location is found for the UE associated with the IP address, i.e. the IP address is not in use. In this case the IAP 19 can safely reject any received packets intended for that IP address, since the IAP 19 can be ensured that it will get an update when the IP address becomes assigned to a device (e.g. UE 10) and the update will contain the device location. This mechanism for instance advantageously allows a longer timer interval in case it is combined with the embodiment described with reference to FIG. 4.

For the embodiment where a set of IP addresses are allocated by the CP node, at each IAP 19, an IP address may be:
a) unused—outside the allocated set; wherein packets intended for this address shall be dropped;
b) allocated—inside the allocated set, but not yet queried: wherein a query is made to the LR. For these IP addresses, two scenarios are possible (but which are unknown to the IAP):
   1) the packets can belong to devices which have not yet received a packet via this IAP; or
   2) the packets do not belong to any device;
c) queried—location unknown; wherein packets intended for this address shall be dropped. In a preferred embodiment, the CP node 20 explicitly informs of the device location when this IP address is assigned to a device; or
d) queried—location known; wherein the packets are forwarded with the location added as a tag.

Some IP addresses may belong to category b2 if a new set of IP addresses is allocated or when an IP address times out in category c. IP addresses may belong to category c if a device has left or if a packet arrived to an IP address in category b2, which usually is an indication of an error or an attack, since packets shall not in general arrive to unallocated IP addresses. The CP node shall strive to minimize the number of IP addresses in categories b2 and c by re-allocating these addresses to incoming devices; IP addresses in categories b2 are open to attacks, while IP addresses in category c consume resources because the IAP subscribes to these packets.

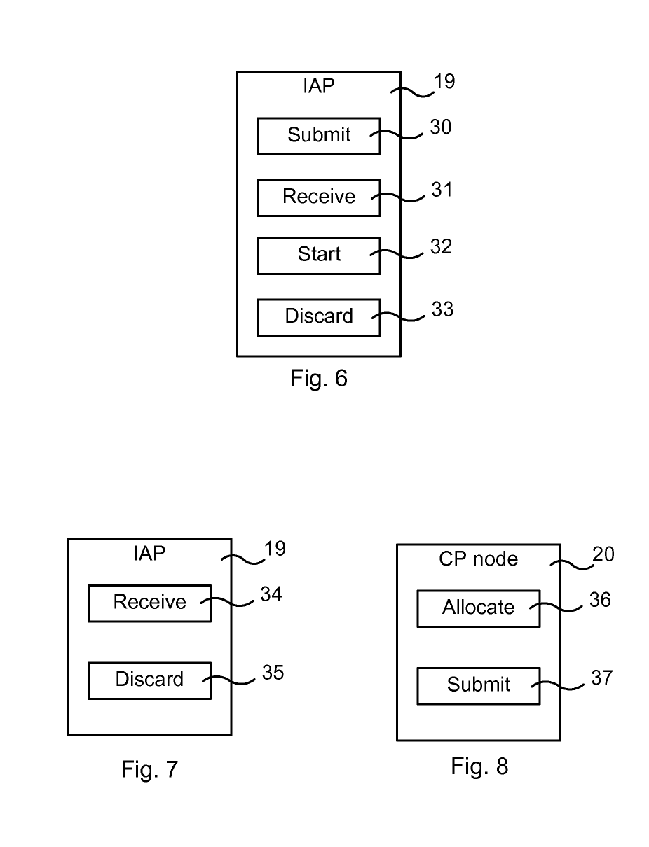

FIG. 6 shows an IAP 19 according to an embodiment of the invention configured to manage received data intended for an IP address in a mobile service chaining network. The IAP 19 comprises submitting means 30 adapted to submit a query to obtain, from an LR, an indication of a current location of a device designated by the IP address being included in the query, receiving means 31 adapted to receive a reply indicating that the IP address included in the query is not in use, starting means 32 adapted to start a timer upon receiving the reply that the IP address is not in use, and discarding means 33 adapted to discard received data intended for the IP address not in use until expiry of a set timer interval. The means 30-33 may comprise a communications interface for receiving and providing information, and further a local storage for storing data, and may (in analogy with the description given in connection to FIG. 1) be implemented by a processor embodied in the form of one or more microprocessors arranged to execute a computer program downloaded to a suitable storage medium associated with the microprocessor, such as a RAM, a Flash memory or a hard disk drive.

FIG. 7 shows an IAP 19 according to another embodiment of the invention configured to manage received data intended for an IP address in a mobile service chaining network. The IAP 19 comprises receiving means 34 adapted to receive an indication of IP addresses not being in use and to receive data intended for a particular IP address, and further discarding means 35 adapted to discard the received data intended for the particular IP address, if the particular IP address is not in use. The means 34, 35 may comprise a communications interface for receiving and providing information, and further a local storage for storing data, and may (in analogy with the description given in connection to FIG. 1) be implemented by a processor embodied in the form of one or more microprocessors arranged to execute a computer program downloaded to a suitable storage medium associated with the microprocessor, such as a RAM, a Flash memory or a hard disk drive.

FIG. 8 shows a CP node 20 according to another embodiment of the invention configured to allocate IP addresses to at least one IAP in a mobile service chaining network. The CP node 20 comprises allocating means 36 adapted to allocate a set of IP addresses upon receiving a request to allocate at least one IP address included in the set to a device, and submitting means 37 adapted to submit, to the at least one IAP, an indication of the allocation of the set of IP addresses. The means 36, 37 may comprise a communications interface for receiving and providing information, and further a local storage for storing data, and may (in analogy with the description given in connection to FIG. 1) be implemented by a processor embodied in the form of one or more microprocessors arranged to execute a computer program downloaded to a suitable storage medium associated with the microprocessor, such as a RAM, a Flash memory or a hard disk drive.

The invention has mainly been described above with reference to a few embodiments. However, as is readily appreciated by a person skilled in the art, other embodiments than the ones disclosed above are equally possible within the scope of the invention, as defined by the appended patent claims.

1. A Method performed by an Internet Protocol Advertisement Point, IAP, in a mobile service chaining network of managing received data intended for an Internet Protocol, IP, address, comprising:
submitting a query to obtain an indication of a current location of a device designated by the IP address being included in the query, from a Location Registry, LR;
receiving a reply indicating that the IP address included in the query is not in use;
starting a timer upon receiving the reply that the IP address is not in use; and
discarding received data intended for the IP address not in use until expiry of a set timer interval.

2. The method of claim 1, further comprising;
discarding buffered data intended for the IP address not in use, which buffered data was received before receiving the reply that the IP address is not in use.

3. A Method performed by an Internet Protocol Advertisement Point, IAP, in a mobile service chaining network of managing received data intended for an Internet Protocol, IP, address, comprising:
receiving an indication of IP addresses not being in use;
receiving data intended for a particular IP address; and
discarding the received data intended for the particular IP address, if said particular IP address is not in use.

4. The method of claim 1, further comprising:
receiving an indication that an IP address previously indicated as not being in use now is in use, along with an indication of a current location of a device associated with the IP address now being in use; and
forwarding any received data intended for the IP address now being in use towards the IP address now in use.

5. The method of claim 1, further comprising:
receiving an indication that an IP address previously indicated as not being in use now is in use;
submitting a query for an indication of a current location of a device associated with the IP address now being in use;
receiving, in response to said query, the indication of a current location of a device associated with the IP address now being in use; and
forwarding any received data intended for the IP address now being in use towards the IP address now in use.

6. A method performed by a control plane node of allocating Internet Protocol, IP, addresses to at least one Internet Protocol Advertisement Point, IAP, in a mobile service chaining network, comprising:
allocating a set of IP addresses upon receiving a request to allocate at least one IP address included in the set to a device; and
submitting, to the at least one IAP, an indication of the allocation of the set of IP addresses.

7. The method of claim 6, the submitting further comprising:
submitting, to the at least one IAP, an indication of a current location of the device associated with the at least one IP address being allocated, wherein the at least one IAP forwards any received data intended for said at least one IP address towards the at least one IP address.

8. The method of claim 6, further comprising:
receiving a query to obtain an indication of a current location of a device designated by an IP address being included in the query, wherein in case the IP address of the query is an IP address included in the set but not allocated to a device; and
replying that the IP address included in the query is not in use.

9. The method of claim 6, further comprising:
submitting an indication of a current location of a device associated with an allocated IP address now being in use, if a response to a previous query indicated that the allocated IP address was not in use.

10. An Internet Protocol Advertisement Point, IAP, configured to manage received data intended for an Internet Protocol, IP, address in a mobile service chaining network, which comprises a processing unit and a memory, said memory containing instructions executable by said processing unit, whereby said IAP is operative to:
submit a query to obtain an indication of a current location of a device designated by the IP address being included in the query, from a Location Registry, LR;
receive a reply indicating that the IP address included in the query is not in use;
start a timer upon receiving the reply that the IP address is not in use; and
discard received data intended for the IP address not in use until expiry of a set timer interval.

11. The IAP of claim 10, further being operative to;
discard buffered data intended for the IP address not in use, which buffered data was received before receiving the reply that the IP address is not in use.

12. An Internet Protocol Advertisement Point, IAP, configured to manage received data intended for an Internet Protocol, IP, address in a mobile service chaining network, which comprises a processing unit and a memory, said memory containing instructions executable by said processing unit, whereby said IAP is operative to:
receive an indication of IP addresses not being in use;
receive data intended for a particular IP address; and
discard the received data intended for the particular IP address, if said particular IP address is not in use.

13. The IAP of claim 10, further being operative to:
receive an indication that an IP address previously indicated as not being in use now is in use, along with an indication of a current location of a device associated with the IP address now being in use; and
forward any received data intended for the IP address now being in use towards the IP address now in use.

14. The IAP of claim 11, further begin operative to:
receive an indication that an IP address previously indicated as not being in use now is in use;
submit a query for an indication of a current location of a device associated with the IP address now being in use;
receive, in response to said query, the indication of a current location of a device associated with the IP address now being in use; and
forward any received data intended for the IP address now being in use towards the IP address now in use.

15. A Control plane node configured to allocate Internet Protocol, IP, addresses to at least one Internet Protocol Advertisement Point, IAP, in a mobile service chaining network, which comprises a processing unit and a memory, said memory containing instructions executable by said processing unit, whereby said control plane node is operative to:
allocate a set of IP addresses upon receiving a request to allocate at least one IP address included in the set to a device; and
submit, to the at least one IAP, an indication of the allocation of the set of IP addresses.

16. The control plane node of claim 15, further being operative to:
submit, to the at least one IAP, an indication of a current location of the device associated with the at least one IP address being allocated, wherein the at least one IAP forwards any received data intended for said at least one IP address towards the at least one IP address.

17. The control plane node of claim 15, further being operative to:
receive a query to obtain an indication of a current location of a device designated by an IP address being included in the query, wherein in case the IP address of the query is an IP address included in the set but not allocated to a device; and
reply that the IP address included in the query is not in use.

18. The control plane node of claim 15, further comprising:
submitting an indication of a current location of a device associated with an allocated IP address now being in use, if a response to a previous query indicated that the allocated IP address was not in use.

19. (canceled)

20. (canceled)

21. A non-transitory computer readable medium comprising instructions executable by at least one processor of a node whereby the node is operable to:
submit a query to obtain an indication of a current location of a device designated by the IP address being included in the query, from a Location Registry, LR;
receive a reply indicating that the IP address included in the query is not in use;
start a timer upon receiving the reply that the IP address is not in use; and
discard received data intended for the IP address not in use until expiry of a set timer interval.
